(19) United States
(12) Patent Application Publication
(10) Pub. No.: US 2009/0208790 A1
(43) Pub. Date: Aug. 20, 2009

(54) FLUID RECYCLING APPARATUS AND FUEL CELL SYSTEM HAVING THE FLUID RECYCLING APPARATUS

(75) Inventors: Jung-Kurn Park, Suwon-si (KR); Seong-Kee Yoon, Suwon-si (KR); Hye-Jung Cho, Suwon-si (KR); Ichiro Yanagisawa, Tokyo (JP); Hideki Furukawa, Tokyo (JP); Mitsutaka Fujii, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co.,Ltd., Suwon-si (KR)

(21) Appl. No.: 12/353,138

(22) Filed: Jan. 13, 2009

(30) Foreign Application Priority Data
Feb. 19, 2008 (KR) 10-2008-0015007

(51) Int. Cl. H01M 8/06; F04F 99/00

(52) U.S. Cl. 429/21; 417/48

(57) ABSTRACT

An improved fluid recycling apparatus and a fuel cell system comprising the same effectively recycle moisture contained in fluid circulating in a fuel cell system and operate independent of orientation. The fluid recycling apparatus includes an electric penetration pump and a gas/liquid separation unit. The electric penetration pump has first and second electrodes and an electric penetration layer interposed between the first and second electrodes. The electric penetration pump directs a liquefied fluid through an electric fluid passage formed in the electric penetration layer by applying a voltage between the first electrode and the second electrode. The gas/liquid separation unit is disposed upstream of the electric fluid passage, contacting the electric penetration pump, and comprises a porous material that can absorb the liquefied fluid. The gas/liquid separation unit comprises at least one fluid inflow hole through which a mixture of a gaseous fluid and a liquefied fluid is introduced, and at least one gas discharge hole communicating with the fluid inflow hole configured for discharging the gaseous fluid.

### CROSS-REFERENCE TO RELATED APPLICATION

This application claims priority to and the benefit of Korean Patent Application No. 10-2008-0015007, filed in the Korean Intellectual Property Office on Feb. 19, 2008, the entire contents of which is incorporated herein by reference.

### BACKGROUND

1. Technical Field

The present disclosure relates to a fuel cell system and, more particularly, to a fluid recycling apparatus effectively recycles water from fluid circulating in the fuel cell system and operates independent of orientation.

2. Description of the Related Art

Fuel cell systems generate electrical energy through an electrochemical reaction between hydrogen and oxygen. Fuel cells are classified into a variety of types according to fuel used such as polymer electrolyte membrane fuel cells (PEMFCs), direct methanol fuel cells (DMFCs), and the like.

PEMFCs use a hydrogen ion exchange polymer membrane as an electrolyte membrane. A fuel containing hydrogen electrochemically reacts with an oxidizing gas containing the oxygen, thereby continuously generating electrical energy and heat. Typically, PEMFCs exhibit excellent output characteristics compared with other types of fuel cells, and have lower operating temperatures. In addition, PEMFCs have quick start-up and response properties. Fuel cell systems using PEMFCs have been used in a variety of power source applications such as portable power sources or battery-alternative power sources. The fuel cell systems are generally designed to supply the oxidizing gas and fuel to each of fuel cell stacks.

In DMFCs, a liquid fuel such as methanol is directly supplied to each fuel cell stack without using a fuel reformer. The DMFCs receive the liquid fuel and air and generate electrical energy by an oxidation reaction of the fuel and a reduction reaction of the oxidizing gas. Fuel cell systems using DMFCs are relatively simple in structure, and thus, have been used as portable power sources and small-sized power sources.

In the above-described fuel cell systems, after the fuel electrochemically reacts with the oxidizing gas, unreacted fuel and carbon dioxide (CO₂) are discharged through an anode outlet and unreacted oxidizing gas and water are discharged through a cathode outlet. In order to recycle the unreacted fuel, the carbon dioxide is discharged separately, and the unreacted fuel is recovered and recycled to the fuel cell stack. Further, the unreacted oxidizing gas is discharged separately, and the water (moisture) generated by the electrochemical reaction is mixed with the unreacted fuel and supplied to the fuel cell stack.

In a fuel cell system, the moisture generated by the electrochemical reaction is discharged through the cathode outlet mixed with the unreacted oxidizing gas. Therefore, the typical fuel cell system includes a fluid recycling apparatus for separating the moisture from the unreacted oxidizing gas. The fluid recycling apparatus is designed to condense the unreacted oxidizing gas discharged from the fuel cell stack at a predetermined temperature or lower, to change the vapor-phase moisture contained in the oxidizing gas into water, thereby separating the condensed moisture from the oxidizing gas by gravity.

When a fuel cell system such as a DMFC is used as a portable or small-sized power source, the fluid recycling apparatus may be shaken or rotated. As a result, the water separated from the unreacted oxidizing gas may be remixed with the unreacted oxidizing gas or leaked from the fuel cell system. This problem is generally expressed as “an orientation free performance is low.” That is, since the typical fuel cell system has a low orientation free performance, the power efficiency of the typical fuel cell system is reduced.

### SUMMARY OF THE INVENTION

Exemplary embodiments of the present disclosure provide a fluid recycling apparatus that can separate liquid and gas that are contained in a fluid from each other using electroosmosis, and a fuel cell system having the fluid recycling apparatus.

Exemplary embodiments of the present disclosure also provide a fluid recycling apparatus with improved orientation free performance by reliably separating liquid and gas that are contained in a fluid from each other even when the apparatus is shaken and/or rotated, and a fuel cell system having the fluid recycling apparatus.

Some embodiments provide a fluid recycling apparatus and a fuel cell system comprising the same. The fluid recycling apparatus separates the cathode exhaust from a fuel cell stack into liquid water and a vapor phase, which is exhausted out of the system. The water is mixed with a fuel, and the mixture fed into a fuel inlet fluidly connected to the anode of the fuel stack, thereby improving the efficiency of the electrochemical reaction therein. Embodiments of the fluid recycling apparatus provide orientation-free operation. The fuel recycling apparatus comprises an optional fluid dispersion unit disposed upstream of a gas-liquid separation unit disposed upstream of a penetration or electroosmotic pump. The fluid dispersion unit comprises a porous material with a mean pore diameter greater than a mean pore diameter of a material of the gas-liquid separation unit. The gas-liquid separation unit comprises a fluid inlet fluidly connected to the cathode exhaust of the fuel cell stack, and a gas exhaust outlet fluidly connected to the fluid inlet, through which gas is exhausted out of the gas-liquid separation unit. Some embodiments of the fluid recycling apparatus further comprise heat exchanger in thermal contact with at least a portion of the gas-liquid separation unit and/or the fluid dispersion unit. The penetration pump comprises a first electrode, a second electrode, and a penetration layer disposed between the first electrode and the second electrode. Applying a suitable potential between the first electrode and the second electrode induces an electroosmotic fluid flow through the penetration layer.

According to an exemplary embodiment of the present disclosure, a fluid recycling apparatus includes an electric penetration pump and a gas/liquid separation unit. The electric penetration pump has first and second electrodes and an electric penetration layer interposed between the first and second electrodes. The electric penetration pump directs liquefied fluid to an electric fluid passage formed in the electric penetration layer by applying a voltage between the first electrode to the second electrode. The gas/liquid separation unit is disposed upstream of the electric fluid passage while contacting the electric penetration pump and comprises a porous material that can absorb the liquefied fluid. The gas/liquid separation unit comprises at least one fluid inflow hole into which a mixture of a gaseous fluid and a liquefied fluid is introduced, and at least one gas discharge hole communicating with the fluid inflow hole and configured for discharging the gaseous fluid.

The gas/liquid separation unit may have a mean pore diameter that is less than a mean diameter of the fluid inflow holes, and the mean pore diameter may be about 1-100 μm.

The fluid recycling apparatus may further include a fluid dispersion unit disposed upstream of the gas-liquid separation unit with a mean pore diameter greater than a mean pore diameter of the gas/liquid separation unit.

The fluid dispersion unit may comprise a plurality of beads each having a diameter of about 0.3-3 mm.

The fluid recycling apparatus may further include a heat exchanger attached to outer circumferences of the gas/liquid separation unit and the fluid dispersion unit to cool the gas/liquid separation unit and the fluid dispersion unit to a predetermined temperature.

The heat exchanger may include a heat pipe that exchanges heat as a refrigerant flows along the heat pipe.

Alternatively, the heat exchanger may include a case attached on outer circumferences of the gas/liquid separation unit and the fluid dispersion unit, a plurality of fins protruding from the case, and a cooling fan directing cool air toward the fins.

Alternatively, the heat exchanger may include a case attached to outer circumferences of the gas/liquid separation unit and the fluid dispersion unit, a plurality of fins protruding from the case, and a sub-cooling unit disposed into the gas/liquid separation unit and the fluid dispersion unit.

The sub-cooling unit may include a plurality of fins.

Alternatively, the sub-cooling unit may include a heat pipe that exchanges heat as a refrigerant flows along the heat pipe and/or a metal bar having a desired thermal conductivity.

According to another exemplary embodiment of the present disclosure, a fuel cell system includes a fuel cell main body configured for generating electrical energy by electrochemically reacting hydrogen and oxygen with each other, a fuel supply unit configured for supplying fuel containing hydrogen to the fuel cell main body, an oxidizing gas supply unit configured for supplying oxidizing gas containing the oxygen to the fuel cell main body, and a fluid recycling apparatus configured for separating fluid discharged from the fuel cell main body into a liquefied fluid and a gaseous fluid. The fluid recycling apparatus includes an electric penetration pump and a gas/liquid separation unit. The electric penetration pump has first and second electrodes, and an electric penetration layer interposed between the first and second electrodes. The electric penetration pump directs liquefied fluid to an electric fluid passage formed in the electric penetration layer by applying a voltage from the first electrode to the second electrode. The gas/liquid separation unit is disposed upstream of the electric fluid passage while contacting the electric penetration pump and comprises a porous material that can absorb the liquefied fluid. The gas/liquid separation unit comprises at least one fluid inflow hole into which a mixture of a gaseous fluid and a liquefied fluid is introduced, and at least one gas discharge hole communicating with the fluid inflow hole and discharging the gaseous fluid.

Some embodiments provide a fluid recycling apparatus and a fuel cell system comprising the same, the fluid recycling apparatus comprising: an electric penetration pump comprising a first electrode, a second electrode, and an electric penetration layer interposed between the first and second electrodes, wherein the electric penetration pump is configured to direct liquefied fluid through an electric fluid passage disposed in the electric penetration layer by applying a voltage between the first electrode and the second electrode; and a gas/liquid separation unit disposed upstream of the electric fluid passage and contacting the electric penetration pump, the gas/liquid separation unit comprising a porous material configured to absorb the liquefied fluid, wherein the gas/liquid separation unit comprises at least one fluid inflow hole configured for receiving a mixture of a gaseous fluid and a liquefied fluid, and at least one gas discharge hole in fluid communication with the fluid inflow hole and configured for discharging the gaseous fluid.

In some embodiments, the gas/liquid separation unit comprises a material with a mean pore diameter less than a mean diameter of the fluid inflow hole, and the mean pore diameter is about 1-100 μm

Some embodiments further comprise a fluid dispersion unit disposed upstream of the gas/liquid separation unit, wherein the fluid dispersion unit comprises a material with a mean pore diameter greater than a mean pore diameter of the gas/liquid separation unit. In some embodiments, the fluid dispersion unit comprises a plurality of beads, each with a diameter of about 0.3-3 mm.

Some embodiments further comprise a heat exchanger contacting at least portions of outer circumferences of the gas/liquid separation unit and fluid dispersion unit, wherein the heat exchanger is configured to cool the gas/liquid separation unit and fluid dispersion unit to a predetermined temperature. In some embodiments, the heat exchanger comprises a heat pipe comprising a refrigerant therein. In some embodiments, the heat exchanger comprises a case contacting at least portions of outer circumferences of the gas/liquid separation unit and the fluid dispersion unit, a plurality of fins protruding from the case, and a cooling fan configured for directing cooling air toward the fins. In some embodiments, the heat exchanger comprises a case contacting at least portions of outer circumferences of the gas/liquid separation unit and the fluid dispersion unit, a plurality of fins protruding from the case, and a sub-cooling unit inserted into the gas/liquid separation unit and the fluid dispersion unit.

In some embodiments, the sub-cooling unit comprises a plurality of fins. In some embodiments, the sub-cooling unit comprises a heat pipe comprising a refrigerant therein. In some embodiments, the sub-cooling unit comprises a metal bar having a desired thermal conductivity.

Some embodiments of the fuel cell system further comprise: a fuel cell main body configured for generating electrical energy by electrochemically reacting hydrogen and oxygen with each other; a fuel supply unit fluidly connected to the fuel cell main body, configured for supplying a hydrogen-containing fuel to the fuel cell main body; and an oxidizing gas supply unit fluidly connected to the fuel cell main body, configured for supplying an oxidizing gas comprising oxygen to the fuel cell main body.

In some embodiments, the fluid recycling apparatus is fluidly connected to a cathode outlet of the fuel cell main body, and configured for separating a fluid discharged through the cathode outlet into water and unreacted oxidizing gas.

### BRIEF DESCRIPTION OF THE DRAWINGS

FIG. 1 is a schematic diagram of a fluid recycling apparatus according to a first exemplary embodiment of the present disclosure.

FIG. 2 is a cross-sectional view of the fluid recycling apparatus of FIG. 1, taken in a fluid flow direction.

FIG. 3 is an enlarged photograph illustrating characteristics of a porous material of a gas/liquid separation unit of FIG. 2.

FIG. 4 is a cross-sectional view of a fluid recycling apparatus according to a second exemplary embodiment of the present disclosure.

FIG. 5 is an enlarged photograph of a fluid dispersion unit of FIG. 4.

FIG. 6 is a cross-sectional view of a fluid recycling apparatus according to a third exemplary embodiment of the present disclosure.

FIG. 7 is a cross-sectional view of a fluid recycling apparatus according to a fourth exemplary embodiment of the present disclosure.

FIG. 8 is a cross-sectional view of a fluid recycling apparatus according to a fifth exemplary embodiment of the present disclosure.

FIG. 9 is a cross-sectional view of a fluid recycling apparatus according to a sixth exemplary embodiment of the present disclosure.

FIG. 10 is a cross-sectional view of a fluid recycling apparatus according to a seventh exemplary embodiment of the present disclosure.

FIG. 11 is a cross-sectional view of a fluid recycling apparatus according to an eighth exemplary embodiment of the present disclosure.

FIG. 12 is a schematic diagram of a fuel cell system according to an exemplary embodiment.

### DETAILED DESCRIPTION OF CERTAIN EMBODIMENTS

Certain embodiments will be described more fully hereinafter with reference to the accompanying drawings, in which exemplary embodiments are shown. As those skilled in the art would realize, the described embodiments may be modified in various different ways, all without departing from the spirit or scope of the present disclosure.

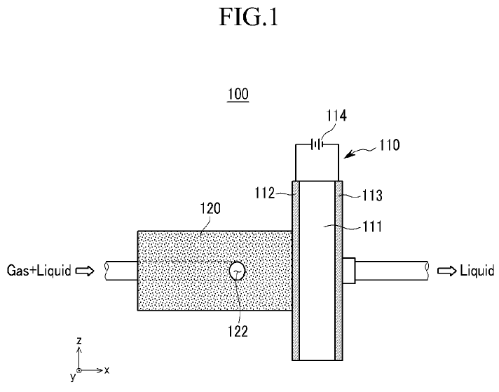

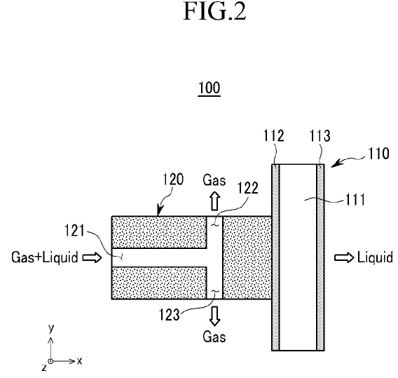

FIG. 1 is a schematic diagram of a fluid recycling apparatus 100 according to a first exemplary embodiment of the present disclosure, and FIG. 2 is a cross-sectional view of the fluid recycling apparatus of FIG. 1, taken in a fluid flow direction.

As shown in FIGS. 1 and 2, a fluid recycling apparatus 100 in accordance with a first exemplary embodiment of the present disclosure includes an electric penetration or electroosmotic pump 110 and a gas/liquid separation unit 120. The fluid recycling apparatus 100 separates moisture from a fluid. For example, the fuel cell system uses air from the atmosphere as an oxidizing gas. Moisture generated by the electrochemical reaction in a fuel cell stack is discharged mixed with unreacted air. The fluid containing the unreacted air and moisture is separated into air and liquid water. The liquid water separated from the fluid is recycled by being redirected to the fuel cell stack. The fluid recycling apparatus 100 is designed to separate the liquefied fluid and the gaseous fluid from each other.

The electric penetration pump 110 includes first and second electrodes 112 and 113 and an electric penetration layer 111 interposed between the first and second electrodes 112 and 113. That is, the first and second electrodes 112 and 113 are disposed on opposite surfaces of the penetration layer 111. The electric penetration layer 111 comprises a material that can transfer an electric voltage. The electric penetration layer 111 comprises a minute electric passage through which the liquefied fluid passes. The electric penetration pump 110 further includes a power source 114 coupled to the first electrode 112 to the second electrode 113. The power source 114 is a device, such as a battery, a capacitor, a fuel cell, a commercial power source, or the like. The power source 114 applies a predetermined voltage between the first and second electrodes 112 and 113. The predetermined voltage is sufficient to cause the liquefied fluid to electro-osmotically flow through the electric passage of the electric penetration layer 111. The predetermined voltage varies depending on a gap between the first and second electrodes 112 and 113. For example, the predetermined voltage may be within a range from about several volts to about several tens of volts.

The gas/liquid separation unit 120 is disposed near to and upstream of the electric passage, in fluid connection with the electric penetration pump 110, for example contacting the electric penetration pump 110. That is, if a positive terminal of the power source 114 is connected to the first electrode 112, the gas/liquid separation unit 120 is fluidly connected to the first electrode 112 upstream of the electric passage. The gas/liquid separation unit 120 comprises porous material having a self-filling structure that can absorb the liquefied fluid.

The gas/liquid separation unit 120 comprises a fluid inflow hole 121 and gas discharge holes 122 and 123 communicating with the fluid inflow hole 121, as best seen in FIG. 2. The mixed gaseous fluid and the liquefied fluid enter the gas/liquid separation unit 120 through the fluid inflow hole 121. Since the gas/liquid separation unit 120 comprises a porous material, the liquefied fluid and the gaseous fluid can flow through the gas/liquid separation unit 120 even when the gas/liquid separation unit 120 does not comprise a fluid inflow hole 121. However, each of the pores of the gas/liquid separation unit 120 is small that it can be filled with the liquefied fluid, which may cause a huge loss in pressure of the fluid.

Therefore, the fluid inflow hole 121 extends through the gas/liquid separation unit 120 in accordance with the first exemplary embodiment of the present disclosure so that the gaseous fluid and the liquid fluid can be more effectively introduced. Then, the liquefied fluid is absorbed in pores of the porous material and directed toward the electric penetration pump 110, and the gaseous fluid is discharged out through the gas discharge holes 122 and 123. Some embodiments comprise one or more fluid inflow holes 121 and/or two or more gas discharge holes 122 and 123 in consideration of fluid processing capability.

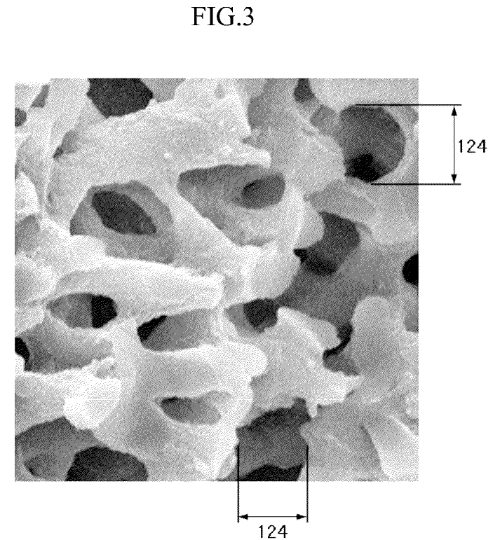

FIG. 3 is an enlarged photograph of the gas/liquid separation unit of FIG. 2, illustrating the porous material characteristics thereof

As shown in FIGS. 1 through 3, a mean pore diameter 124 of the porous material of the gas/liquid separation unit 120 is less than a mean diameter of the fluid inflow holes 121. Then, the liquefied fluid is absorbed in the pores of the gas/liquid separation unit 120 comprising the porous material. In some embodiments in which the mean pore diameter 124 of the gas/liquid separation unit 120 is about 1-100 μm, the liquefied fluid absorption effect of the gas/liquid separation unit 120 by capillarity is excellent. In some embodiments, if the mean pore diameter 124 of the gas/liquid separation unit 120 is less than about 1 μm, the liquefied fluid cannot easily flow through the pores of the gas/liquid separation unit 120. If the mean pore diameter 124 of the gas/liquid separation unit 120 is greater than about 100 μm, it is difficult to selectively absorb only the liquefied fluid and thus the fluid absorption performance and the fluid recovery rate are reduced.

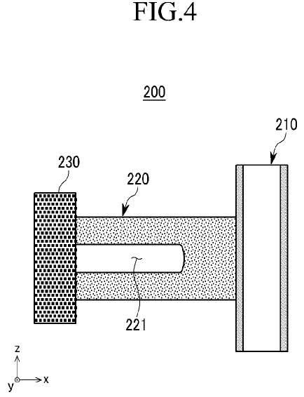

FIG. 4 is a cross-sectional view of a fluid recycling apparatus 200 according to a second exemplary embodiment of the present disclosure.

As shown in FIG. 4, like the fluid recycling apparatus 100 of FIGS. 1 and 2, a fluid recycling apparatus 200 in accordance with a second exemplary embodiment of the present disclosure includes an electric penetration pump 210 and a gas/liquid separation unit 220. According to this exemplary embodiment, the fluid recycling apparatus 200 further includes a fluid dispersion unit 230 located upstream of the gas/liquid separation unit 220, which comprises a fluid inflow hole 221. The fluid dispersion unit 230 has a mean pore diameter that is greater than a mean pore diameter of the gas/liquid separation unit 220. In some embodiments, the fluid dispersion unit 230 comprises an aggregate or composite of elements, such as beads, pulverized material, and/or fibers. Pores are formed between the elements.

The fluid primarily passes through the fluid dispersion unit 230 and subsequently flows into the gas/liquid separation unit 220. Since the fluid is introduced into the gas/fluid separation unit 220 after being uniformly dispersed by the fluid dispersion unit 230, the fluid is not concentrated at a specific region of the gas/fluid separation unit 220. Further, even when a large amount of fluid is supplied, the fluid is primarily stored in the fluid dispersion unit 230 and subsequently introduced into the gas/liquid separation unit 220. Therefore, the liquefied fluid can be more effectively recovered by the gas/liquid separation unit 220.

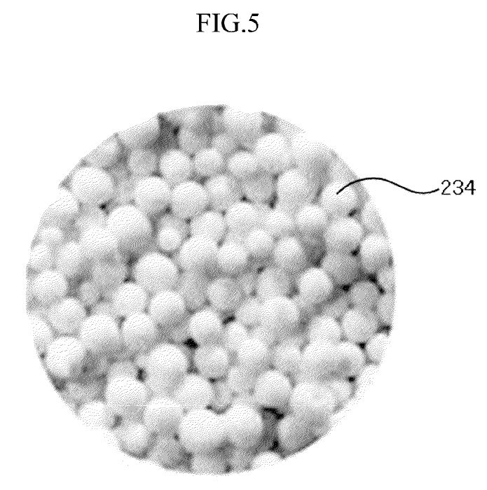

FIG. 5 is an enlarged photograph of the fluid dispersion unit of FIG. 4.

As shown in FIGS. 4 and 5, the fluid dispersion unit 230 exemplarily comprises a plurality of beads 234 each having a diameter of about 0.3-3 mm. In some embodiments, when the diameter of the beads 234 is less than about 0.3 mm, the diameter of the pores between the beads 234 is reduced and thus the fluid cannot effectively flow. This incurs a significant pressure loss. In some embodiments, when the diameter of the beads 234 is greater than about 3 mm, the diameter of the pores between the beads 234 increases and thus the fluid dispersion and storage effect are significantly reduced.

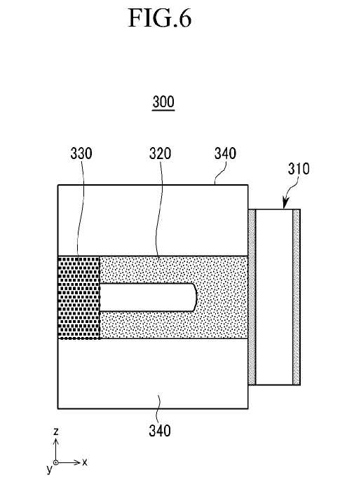

FIG. 6 is a cross-sectional view of a fluid recycling apparatus 300 according to a third exemplary embodiment of the present disclosure.

As shown in FIG. 6, like the fluid recycling apparatus 200 of FIG. 3, a fluid recycling apparatus 300 in accordance with a third exemplary embodiment of the present disclosure includes an electric penetration pump 310, a gas/liquid separation unit 320, and a fluid dispersion unit 330. The fluid recycling apparatus 300 in accordance with this second exemplary embodiment further includes a heat exchanger 340 functioning as a heat sink for cooling the gas/liquid separation unit 320 and the fluid dispersion unit 330 to a predetermined temperature. The heat exchanger 340 attached to, secured to, and/or contacts at least portions of the outer circumferences of the gas/liquid separation unit 320 and the fluid dispersion unit 330. The heat exchanger 340 absorbs heat generated by the gas/liquid separation unit 320 and the fluid dispersion unit 330, thereby cooling the gas/liquid separation unit 320 and the fluid dispersion unit 330 to the predetermined temperature. Therefore, the gaseous fluid such as water vapor is condensed and phase-changed into a liquid state as the gas/liquid separation unit 320 and the fluid dispersion unit 330 are cooled to the predetermined temperature. As a result, the fluid recycling apparatus 300 can more effectively recover the liquefied fluid.

Although the heat exchanger 340 contacts both the gas/liquid separation unit 320 and the fluid dispersion unit 330 as shown in FIG. 6, the present disclosure is not limited to this configuration. For example, the heat exchanger 340 may be attached to, secured to, and/or contact only the gas/liquid separation unit 320.

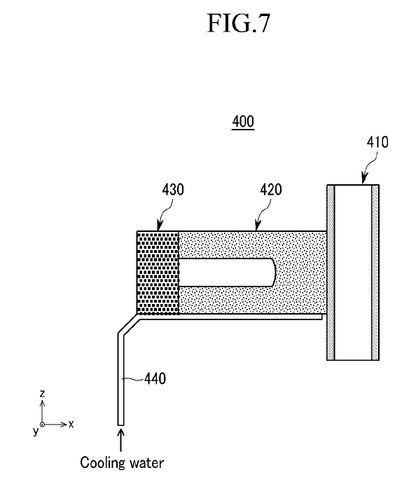

FIG. 7 is a cross-sectional view of a fluid recycling apparatus 400 according to a fourth exemplary embodiment of the present disclosure.

As shown in FIG. 7, like the fluid recycling apparatus 300 of FIG. 6, a fluid recycling apparatus 400 in accordance with a fourth exemplary embodiment of the present disclosure includes an electric penetration pump 410, a gas/liquid separation unit 420, a fluid dispersion unit 430, and a heat exchanger 440. According to a feature of the fourth exemplary embodiment, the heat exchanger comprises a heat pipe is used, unlike the heat exchanger 340 shown in FIG. 6. Cooling water circulates in the heat pipe 440 and thus the gas/liquid separation unit 420 and the fluid dispersion unit 430 can be more effectively cooled.

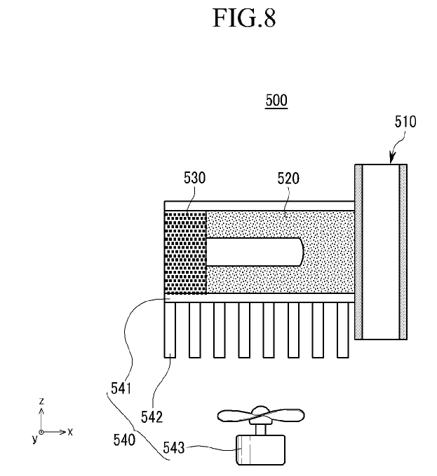

FIG. 8 is a cross-sectional view of a fluid recycling apparatus 500 according to a fifth exemplary embodiment of the present disclosure.

As shown in FIG. 8, like the fluid recycling apparatus 300 of FIG. 6, a fluid recycling apparatus 500 in accordance with a fifth exemplary embodiment of the present disclosure includes an electric penetration pump 510, a gas/liquid separation unit 520, a fluid dispersion unit 530, and a heat exchanger 540. The heat exchanger 540 has a different structure from that of the heat exchanger 340 of FIG. 6.

The heat exchanger 540 includes a case 541 attached to, secured to, and/or contacting at least portions of the outer circumferences of the gas/liquid separation unit 520 and the fluid dispersion unit 530, a plurality of fins 542 protruding from an outer surface of the case 541, and a cooling fan 453 operable for directing a stream of cooling air toward the fins 542. At this point, the case 541 and the fins 542 comprise a metal having a high thermal conductivity so that the heat generated by the gas/liquid separation unit 520 and the fluid dispersion unit 530 can be effectively dissipated through the fins 542. By the above-described structure, the heat exchanger 540 can effectively cool the gas/liquid separation unit 520 and the fluid dispersion unit 530.

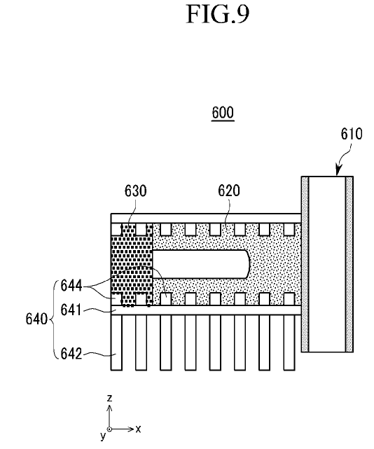

FIG. 9 is a cross-sectional view of a fluid recycling apparatus 600 according to a sixth exemplary embodiment of the present disclosure.

As shown in FIG. 9, like the fluid recycling apparatus 500 of FIG. 8, a fluid recycling apparatus 600 in accordance with a sixth exemplary embodiment of the present disclosure includes an electric penetration pump 610, a gas/liquid separation unit 620, a fluid dispersion unit 630, and a heat exchanger 640. According to a feature of the sixth exemplary embodiment, the fluid recycling apparatus 600 further includes a sub-cooling unit 644 inserted into the gas/liquid separation unit 620 or the fluid dispersion unit 630, unlike the fluid recycling apparatus 500 shown in FIG. 8.

The heat exchanger 640 includes a case 641 attached to, secured to, and/or contacting at least portions of the outer circumferences of the gas/liquid separation unit 620 and the fluid dispersion unit 630, and a plurality of fins 642 protruding from an outer surface of the case 641. The sub-cooling unit 644 includes a plurality of fins protruding from the case 641 into the gas/liquid separation unit 620 and the fluid dispersion unit 630. The heat generated by the gas/liquid separation unit 620 and the fluid dispersion unit 630 can be effectively dissipated through the case 641 and the fins 642. Furthermore, as the sub-cooling unit 644 is further provided, a contact area of the heat exchanger 640 with the gas/liquid separation unit 620 and the fluid dispersion unit 630 can be enlarged and thus the heat generated by the gas/liquid separation unit 620 and the fluid dispersion unit 630 can be more effectively transferred to the case 641.

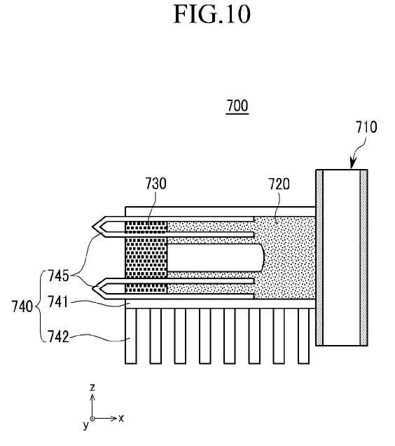

FIG. 10 is a cross-sectional view of a fluid recycling apparatus 700 according to a seventh exemplary embodiment of the present disclosure.

As shown in FIG. 10, like the fluid recycling apparatus 600 of FIG. 9, a fluid recycling apparatus 700 in accordance with a seventh exemplary embodiment of the present disclosure includes an electric penetration pump 710, a gas/liquid separation unit 720, a fluid dispersion unit 730, and a heat exchanger 740. According to a feature of the fluid recycling apparatus of FIG. 10, a cooling structure of the heat exchanger 740 is different from the heat exchanger of FIG. 9.

That is, the heat exchanger 740 includes a case 741 attached to, secured to, and/or contacting at least portions of outer circumferences of the gas/liquid separation unit 720 and fluid dispersion unit 730, a plurality of fins 742 protruding from the case 741, and a sub-cooling unit 745 inserted into the gas/liquid separation unit 720 and fluid dispersion unit 730. The sub-cooling unit 745 includes one or more heat pipes filled with a refrigerant. The heat pipes may comprise a variety of structures, and are inserted into the gas/liquid separation unit 720 and fluid dispersion unit 730. Therefore, the cooling can be more effectively realized.

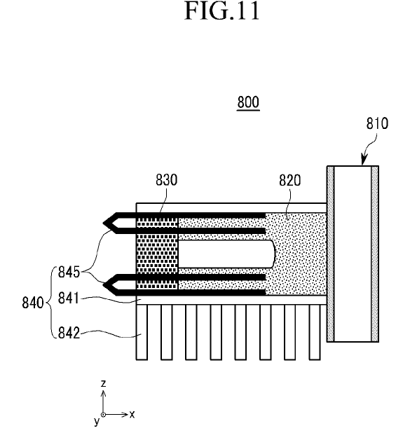

FIG. 11 is a cross-sectional view of a fluid recycling apparatus 800 according to an eighth exemplary embodiment of the present disclosure.

As shown in FIG. 11, like the fluid recycling apparatus 600 of FIG. 9, a fluid recycling apparatus 800 in accordance with an eighth exemplary embodiment of the present disclosure includes an electric penetration pump 810, a gas/liquid separation unit 820, a fluid dispersion unit 830, and a heat exchanger 840. According to a feature of the fluid recycling apparatus of FIG. 11, a cooling structure of the heat exchanger 840 differs from the heat exchanger of FIG. 9.

That is, the heat exchanger 840 includes a case 841 attached to, secured to, and/or contacting at least portions of outer circumferences of the gas/liquid separation unit 820 and fluid dispersion unit 830, a plurality of fins 842 protruding from the case 841, and a sub-cooling unit 845 inserted into the gas/liquid separation unit 820 and fluid dispersion unit 830. The sub-cooling unit 854 includes one or more metal bars having a desired heat conductivity. The metal bars may comprise a variety of structures, and are inserted into the gas/liquid separation unit 820 and fluid dispersion unit 830. Therefore, the cooling can be more effectively realized.

Each of the fluid recycling apparatus 100, 200, 300, 400, 500, 600, 700, and 800 is installed in a fuel cell system and operates as described below.

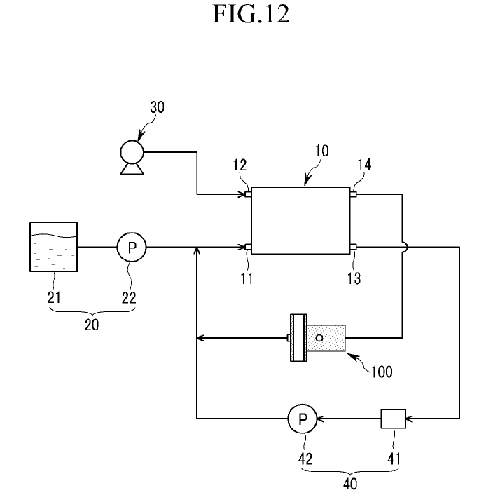

FIG. 12 is a schematic diagram of an embodiment of a fuel cell system having the fluid recycling apparatus of FIG. 1.

As shown in FIG. 12, a fuel cell system includes a fuel cell main body 10 generating electrical energy through an electrochemical reaction between hydrogen and oxygen. The fuel cell main body 10 includes at least one unit cell, which is a minimum unit for generating electrical energy. Generally, the main body 10 is an aggregate of several or several tens of unit cells that are sequentially stacked. End plates (not shown) are respectively coupled to opposite ends of the aggregate of the fuel cell main body 10. By the above-described structural features, the fuel cell main body 10 is also referred to as “fuel cell stack.”

A fuel supply unit 20 supplies a fuel containing hydrogen to the fuel cell main body 10. The fuel may be a hydrocarbon-based fuel (e.g., LNG or LPG). Alternatively, pure hydrogen may be used as the fuel. The fuel supply unit 20 includes a fuel tank 21 for storing the hydrogen-containing fuel, and a first fuel pump 22 for supplying the fuel at a predetermined pressure. The fuel supply unit 20 may further include additional elements such as a fuel reformer in accordance with the type of fuel.

An oxidizing gas supply unit 30 supplies an oxidizing gas containing oxygen to the fuel cell main body 10. Air from the atmosphere may be used as the oxidizing gas. That is, the oxidizing gas supply unit 30 supplies air from the atmosphere to the fuel cell main body 10 using a device such as an air pump.

The hydrogen-containing fuel is introduced into the fuel cell main body 10 through an anode inlet 11 of the fuel cell main body 10. The fuel is used for the electrochemical reaction in the fuel cell main body 10 and subsequently discharged out of the fuel cell main body 10 through an anode outlet 13 of the fuel cell main body 10. The fluid discharged through the anode outlet 13 of the fuel cell main body 10 includes unreacted fuel and carbon dioxide (CO₂) generated by the electrochemical reaction. In order to maximize the use of the fuel, the fuel cell system includes a fuel recycling unit 40 for redirecting the unreacted fuel to the fuel cell main body 10 through the anode inlet 11. The fuel recycling unit 40 is installed on a first recycling line fluidly connecting the anode inlet 11 to the anode outlet 13. The fuel recycling unit 40 includes a carbon dioxide removing unit 41 for separating and discharging the carbon dioxide, and a second fuel pump 42 for supplying the fuel at a predetermined pressure.

The air used as the oxidizing gas is introduced into the fuel cell main body 10 through a cathode inlet 12. The air used for the electrochemical reaction in the fuel cell main body 10 is subsequently discharged through a cathode outlet 14 of the fuel cell main body 10. The fluid discharged through the cathode outlet 14 of the fuel cell main body 10 includes reacted air and moisture generated in the electrochemical reaction. The fuel cell system includes the fluid recycling apparatus 100 for separating the reacted air from the water contained in the fluid discharged from the fuel cell main body 10. The fluid recycling apparatus 100 is installed on a second recycling line extending from the cathode outlet 14 of the fuel cell main body 10 to the first recycling line. Thereafter, the water separated in the fluid recycling apparatus 100 is added to the unreacted fuel, thereby improving the generation of electrons in the electrochemical reaction in the fuel cell main body 10.

Embodiments of the fluid recycling apparatus in accordance with the above-described exemplary embodiments of the present disclosure have a smaller volume than a typical fluid recycling apparatus using gravity. Therefore, the fuel cell system can be miniaturized.

In addition, unlike a typical fluid recycling apparatus, the fluid recycling apparatus in accordance with the above-described exemplary embodiments is not affected by shaking and/or rotation. Therefore, orientation-free performance can be enhanced.

While certain embodiments have been described in connection with what is presently considered to be practical exemplary embodiments, the disclosure is not limited thereto, but, on the contrary, is intended to cover various modifications and equivalent arrangements included within the spirit and scope of the appended claims.

What is claimed is:

1. A fluid recycling apparatus comprising:
an electric penetration pump comprising a first electrode, a second electrode, and an electric penetration layer interposed between the first and second electrodes, wherein the electric penetration pump is configured to direct liquefied fluid through an electric fluid passage disposed in the electric penetration layer by applying a voltage between the first electrode and the second electrode; and
a gas/liquid separation unit disposed upstream of the electric fluid passage and contacting the electric penetration pump, the gas/liquid separation unit comprising a porous material configured to absorb the liquefied fluid,
wherein the gas/liquid separation unit comprises at least one fluid inflow hole configured for receiving a mixture of a gaseous fluid and a liquefied fluid, and at least one gas discharge hole in fluid communication with the fluid inflow hole and configured for discharging the gaseous fluid.

2. The fluid recycling apparatus of claim 1, wherein the gas/liquid separation unit comprises a material with a mean pore diameter less than a mean diameter of the fluid inflow hole, and the mean pore diameter is about 1-100 μm.

3. The fluid recycling apparatus of claim 1, further comprising a fluid dispersion unit disposed upstream of the gas/liquid separation unit, wherein the fluid dispersion unit comprises a material with a mean pore diameter greater than a mean pore diameter of the gas/liquid separation unit.

4. The fluid recycling apparatus of claim 3, wherein the fluid dispersion unit comprises a plurality of beads, each with a diameter of about 0.3-3 mm.

5. The fluid recycling apparatus of claim 4, further comprising a heat exchanger contacting at least portions of outer circumferences of the gas/liquid separation unit and fluid dispersion unit, wherein the heat exchanger is configured to cool the gas/liquid separation unit and fluid dispersion unit to a predetermined temperature.

6. The fluid recycling apparatus of claim 5, wherein the heat exchanger comprises a heat pipe comprising a refrigerant therein.

7. The fluid recycling apparatus of claim 5, wherein the heat exchanger comprises a case contacting at least portions of outer circumferences of the gas/liquid separation unit and the fluid dispersion unit, a plurality of fins protruding from the case, and a cooling fan configured for directing cooling air toward the fins.

8. The fluid recycling apparatus of claim 5, wherein the heat exchanger comprises a case contacting at least portions of outer circumferences of the gas/liquid separation unit and the fluid dispersion unit, a plurality of fins protruding from the case, and a sub-cooling unit inserted into the gas/liquid separation unit and the fluid dispersion unit.

9. The fluid recycling apparatus of claim 8, wherein the sub-cooling unit comprises a plurality of fins.

10. The fluid recycling apparatus of claim 8, wherein the sub-cooling unit comprises a heat pipe comprising a refrigerant therein.

11. The fluid recycling apparatus of claim 8, wherein the sub-cooling unit comprises a metal bar having a desired thermal conductivity.

12. A fuel cell system comprising:
a fuel cell main body configured for generating electrical energy by electrochemically reacting hydrogen and oxygen with each other;
a fuel supply unit fluidly connected to the fuel cell main body, configured for supplying a hydrogen-containing fuel to the fuel cell main body;
an oxidizing gas supply unit fluidly connected to the fuel cell main body, configured for supplying an oxidizing gas comprising oxygen to the fuel cell main body; and
the fluid recycling apparatus of claim 1 fluidly connected to the fuel cell main body.

13. The fuel cell system of claim 12, wherein the fluid recycling apparatus is fluidly connected to a cathode outlet of the fuel cell main body, and configured for separating a fluid discharged through the cathode outlet into water and unreacted oxidizing gas.
